(19) United States
(12) Patent Application Publication
(10) Pub. No.: US 2025/0183696 A1
(43) Pub. Date: Jun. 5, 2025

(54) CIRCUIT ARRANGEMENT FOR ADDITIONAL VOLTAGE SUPPLY IN AN ON-BOARD ELECTRICAL SYSTEM

(71) Applicant: Robert Bosch GmbH, Stuttgart (DE)

(72) Inventors: Eugen Wang, Illingen (DE); Wolfgang Kostorz, Weil Der Stadt (DE)

(21) Appl. No.: 18/967,251

(22) Filed: Dec. 3, 2024

(30) Foreign Application Priority Data
Dec. 4, 2023 (DE) 10 2023 212 173.5

(51) Int. Cl. H02J 7/34; H02J 7/00

(52) U.S. Cl. CPC H02J 7/345; H02J 7/0047; H02J 7/0063; H02J 2207/50; H02J 2310/40

(57) ABSTRACT

A circuit arrangement for additional voltage supply in an on-board electrical system. The on-board electrical system provides an input voltage to at least one consumer via a supply path. The circuit arrangement is to be arranged in parallel with the supply path and includes: an energy store, a detection circuit configured to monitor the input voltage of the at least one consumer, and a first switch configured to switch the energy store, wherein the circuit arrangement is configured to control the first switch depending on a result of the monitoring.

### FIELD

The present invention relates to a circuit arrangement for additional voltage supply in an on-board electrical system, in particular an on-board electrical system in a vehicle, for example a motor vehicle, and to a method for providing an additional voltage supply in an on-board electrical system. The present invention furthermore relates to an on-board electrical system for carrying out the method, which on-board electrical system is in particular configured for use in a vehicle.

### BACKGROUND INFORMATION

The term “on-board electrical system” refers to the totality of all electrical components in a vehicle, in particular in a motor vehicle. Consumers in this on-board electrical system must be supplied with electrical energy, for which purpose power supply devices such as batteries are provided. These power supply devices, which are hereinafter referred to simply as power supplies, provide a supply voltage sufficient to operate the consumer(s).

Power or voltage supplies in control units (ECUs: electronic control units), in particular in central control units, experience voltage fluctuations and voltage interruptions during operation. It should be noted that voltage interruptions generally should not lead to a loss of the intended function.

It is conventional to buffer the supply voltage with capacitors in order to ensure safe operation even in the event of voltage interruptions. The period of time during which there is a voltage interruption is thus bridged.

In conventional solutions, the time that can be bridged in the event of a voltage interruption depends on the voltage that was available at the time of the interruption. A higher voltage therefore allows for a longer bridging time. However, since the input voltage can fluctuate considerably, the period of time that can be bridged varies greatly.

It should be taken into account that the energy that can be stored in a capacitor is proportional to the square of the voltage, i.e.,

E˜U².

Since capacitors are usually oversized because a higher-than-normal dielectric strength is selected, they are not used efficiently. For example, capacitors having a dielectric strength of 35 V are used for a 12 V application.

### SUMMARY

A circuit arrangement, an on-board electrical system, and a method are providing according to the present invention. Example embodiments of the present invention are disclosed herein.

A circuit arrangement for additional voltage supply in an on-board electrical system is provided according to the present invention, wherein the on-board electrical system provides an input voltage to at least one consumer via a supply path. This on-board electrical system is used in particular in a vehicle, in particular in a motor vehicle.

According to an example embodiment of the present invention, the circuit arrangement is to be arranged in parallel with the supply path of the on-board electrical system and has an energy store and a detection circuit, wherein the detection circuit is configured to monitor the input voltage of the consumer. The circuit arrangement furthermore comprises a first switch configured to switch the energy store. This means that the switch can connect or disconnect the energy store depending on its position. The circuit arrangement is furthermore configured to control the switch depending on the result of the monitoring. This means that the switch will either be opened or remain open or be closed depending on the result of the monitoring.

The on-board electrical system presented has a power supply and a consumer, which are connected to each other via a supply path. A circuit arrangement of the type described herein is provided in parallel with the supply path.

According to an example embodiment of the present invention, the on-board electrical system can have additional power supplies, supply paths and consumers. The circuit arrangement described can then be assigned to one or more consumers or supply paths. A plurality of circuit arrangements of the type described can also be used. The importance of the consumers for the operation of the on-board electrical system or the entire vehicle can be taken into account.

A method according to the present invention serves to provide an additional voltage supply in an on-board electrical system of the type described herein according to the present invention, with a circuit arrangement as presented herein according to the present invention. According to an example embodiment of the present invention, in the method, the detection circuit of the circuit arrangement monitors the input voltage of the consumer of the on-board electrical system during operation. If a specified threshold is undershot, the first switch of the circuit arrangement is actuated so that the consumer of the on-board electrical system is supplied with energy from the energy store.

The first switch of the circuit arrangement is thus typically closed by a control signal so that the consumer in the on-board electrical system is supplied with energy from the additional energy store. In this way, voltage fluctuations and voltage interruptions can be bridged, regardless of the voltage previously applied to the consumer.

This is possible since the additional energy store represents an independent energy store that is charged to a predetermined voltage level. Thus, a maximum period of time that can be bridged can also be set by dimensioning the energy store.

The method according to an example embodiment of the present invention can also be used to protect a plurality of consumers in an on-board electrical system, which consumers can be supplied by a plurality of energy stores via a plurality of supply paths.

In this way, when equipped with a boost converter, capacitors are charged to their technical maximum and held available as energy stores. When a voltage interruption is detected, the charged capacitors are connected and thus support the supply voltage for a predefined period of time.

In some example embodiments of the present invention, for example, implementation with a switch or an ideal diode is possible.

The method according to the present invention has, at least in some of its embodiments, a number of advantages:

It allows more efficient use of the capacitors as energy stores, meaning fewer capacitors are required, potentially resulting in lower costs and space requirements.

The duration that can be bridged during an interruption does not depend on the voltage at the time of the interruption, so the required capacity can be limited more precisely.

Further advantages and embodiments of the present invention can be found in the description and the attached drawings.

Of course, the features mentioned above and those still to be explained below can be used not only in the respectively specified combinations but also in other combinations or alone, without departing from the scope of the present invention.

### BRIEF DESCRIPTION OF THE DRAWINGS

FIG. 1 is a block diagram of a circuit arrangement for carrying out a method, according to an example embodiment of the present invention.

FIG. 2 is a flowchart of a possible embodiment of the method according to the present invention.

### DETAILED DESCRIPTION OF EXAMPLE EMBODIMENTS

The present invention is shown schematically in the figures on the basis of embodiments and is described in detail below with reference to the figures.

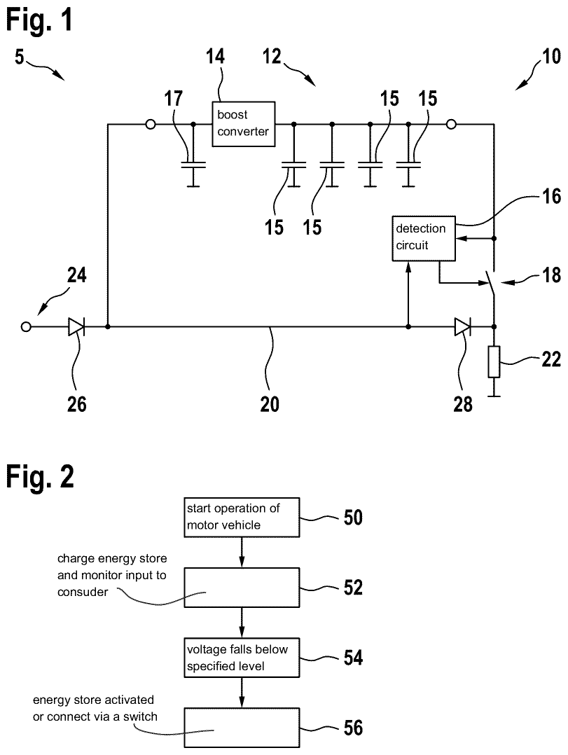

FIG. 1 shows a circuit arrangement that is designated overall by reference sign 10 and is used in an on-board electrical system 5. The illustration shows an energy store 12 that comprises a boost converter 14, for example for a voltage of 35 V, and a number of capacitors 15 connected in parallel. The boost converter 12, also called a step-up converter, can charge the capacitors 15. Another capacitor 17 is also shown.

A detection circuit 16 and a first switch 18 are also provided in the circuit arrangement 10, which switch is in this case designed as an ideal diode having a switching input.

The illustration also shows a supply path 20, which allows a consumer 22 to be supplied by means of a power supply 24, for example by means of a battery. A diode 26 and a second switch 28, which in this case is also designed as an ideal diode, are provided in this supply path 20.

The energy store 12 is thus designed to be parallel to the regular supply path 20 and is charged to a higher voltage level, for example to 35 V, when connected to the power supply 24. The detection circuit 16 detects when the input voltage falls below the level required by the consumer 22.

In this case, the energy from the energy store 12 is transferred to the consumer 22 via the first switch 18. A corresponding control signal is generated for this purpose by the detection circuit 16. This signal is used to control the first switch 18.

The second switch 28 can optionally be connected to the first switch 18.

The second switch 28 prevents the stored energy from flowing back into the on-board electrical system. The diode 26 is optional and serves to protect the boost converter 14 from polarity reversal. The switches 28 and 18 can be implemented as ideal diodes, for example with a control IC having field effect transistor switches. This means that losses are lower than with “normal” diodes. Other switches, for example semiconductor switches, can also be used for the switches 28 and 18.

FIG. 2 is a flowchart of a possible sequence of an embodiment of the described method. In a first step 50, operation of a motor vehicle having an on-board electrical system that has a circuit arrangement for additional voltage supply of the type described herein is started. This on-board electrical system has, among other things, a power supply and a consumer. The power supply provides the consumer with an input voltage.

In a second step 52, the energy store is charged, and an input voltage of the consumer is monitored at the same time. If said input voltage falls below a specified level in a step 54, the energy store is typically activated or connected via a switch in a step 56. The consumer is thus additionally or optionally completely supplied from the energy store.

1-12. (canceled)

13. A circuit arrangement for additional voltage supply in an on-board electrical system, wherein the on-board electrical system provides an input voltage to at least one consumer via a supply path, wherein the circuit arrangement is to be arranged in parallel with the supply path and comprises:
an energy store;
a detection circuit configured to monitor the input voltage of the at least one consumer; and
a first switch configured to switch the energy store, wherein the circuit arrangement is configured to control the first switch depending on a result of the monitoring.

14. The circuit arrangement according to claim 13, wherein the energy store has at least one capacitor.

15. The circuit arrangement according to claim 13, further comprising:
a charge controller configured to charge the energy store.

16. The circuit arrangement according to claim 15, wherein a boost converter is used as the charge controller.

17. The circuit arrangement according to claim 13, wherein the first switch is an ideal diode.

18. An on-board electrical system, comprising:
a power supply;
a consumer, wherein the power supply and the consumer are connected to each other via a supply path; and
a circuit arrangement in parallel with the supply path, wherein the circuit arrangement includes
an energy store,
a detection circuit configured to monitor the input voltage of the at least one consumer, and
a first switch configured to switch the energy store, wherein the circuit arrangement is configured to control the first switch depending on a result of the monitoring.

19. The on-board electrical system according to claim 18, further comprising a second switch in the supply path.

20. The on-board electrical system according to claim 19, wherein the second switch is an ideal diode.

21. The on-board electrical system according to claim 18, wherein a diode is provided in the supply path, the diode providing polarity reversal protection.

22. A method for providing an additional voltage supply in an on-board electrical system having a circuit arrangement, the on-board electrical circuit including:
a power supply,
a consumer, wherein the power supply and the consumer are connected to each other via a supply path, and
a circuit arrangement in parallel with the supply path, wherein the circuit arrangement includes
an energy store,
a detection circuit configured to monitor the input voltage of the at least one consumer, and
a first switch configured to switch the energy store, wherein the circuit arrangement is configured to control the first switch depending on a result of the monitoring,
the method comprising:
monitoring, by the detection circuit of the circuit arrangement, the input voltage of the consumer of the on-board electrical system; and
based on a specified threshold being undershot, actuating the first switch of the circuit arrangement so that the consumer is supplied with energy from the energy store.

23. The method according to claim 22, wherein the energy store of the circuit arrangement is charged during operation of the on-board electrical system.

24. The method according to claim 23, wherein the energy store is charged to a higher level than an energy level of the power supply of the on-board electrical system.
